(19) United States
(12) Patent Application Publication
(10) Pub. No.: US 2026/0175759 A1
(43) Pub. Date: Jun. 25, 2026

(54) TABLE FOR VEHICLE

(71) Applicants: Hyundai Motor Company, Seoul (KR); Kia Corporation, Seoul (KR); NIFCO KOREA Inc., Asan-si (KR)

(72) Inventors: Kyu Rok KIM, Hwaseong-si (KR); Jun Geun OH, Hwaseong-si (KR); Young Tack LEE, Hwaseong-si (KR); Hyo Jin SHIN, Hwaseong-si (KR); Sun Joo KIM, Asan-si (KR)

(21) Appl. No.: 19/186,254

(22) Filed: Apr. 22, 2025

(30) Foreign Application Priority Data
Dec. 19, 2024 (KR) 10-2024-0190704

(51) Int. Cl. B60N 3/00; F16C 11/04

(52) U.S. Cl. CPC B60N 3/001; F16C 11/04

(57) ABSTRACT

A table for a vehicle includes a first table, a second table rotatably connected to the first table, a table rotation portion coupled to a boundary area between the first table and the second table and configured to provide friction to the first table and the second table based on the first table and the second table rotating toward a folded or unfolded position such that the first table and the second table are fixed in a rotated position, and a gear portion coupled to the boundary area and configured to allow the first table and the second table to rotate by an equal rotation angle with respect to the unfolded position.

### CROSS-REFERENCE TO RELATED APPLICATION

This application claims, under 35 U.S.C. § 119 (a), the benefit of and priority to Korean Patent Application No. 10-2024-0190704, filed on Dec. 19, 2024, the entire contents of which are incorporated herein by reference.

### TECHNICAL FIELD

The present disclosure relates to a table for a vehicle. M ore particularly, the present disclosure relates to a table for a vehicle configured to rotate and stop at any angle to allow a user to adjust the angle of the table as desired, improving convenience of use.

### BACKGROUND

A passenger car is equipped with front seats and rear seats, where the front seats include a driver's seat and a passenger seat, and the rear seats are usually mounted in the form of a bench.

In addition to the arrangement of two rows of seats, a sport utility vehicle (SUV) may include seats that are arranged in three or more rows to correspond to a number of passengers. A bus may provide multiple seats to fit many passengers on board, where the multiple seats can be arranged along the left and right sides of the aisle in the bus cabin.

In some cases, a table may be mounted on the back of a front seatback for the convenience of the rear-seat passengers to place items on. The table mounted on the back of the front seatback may be called a seat table. In some cases, the seat table may be fixed at only one angle when unfolded or rotated from the seatback, when the front passenger adjusts the angle of the seatback, the seat table also moves together therewith, and the angle of the table changes.

In some cases, due to the change in angle, the seat table may not be kept horizontal, which may cause the objects placed thereon tilt or fall over.

### SUMMARY

The present disclosure describes a table for a vehicle configured to rotate and stop at any angle by friction applied as a first table and a second table rotate to a folded or unfolded position, allowing a user to adjust the angle of the table as desired, thereby preventing injury caused by carelessness and improving convenience of use.

According to one aspect of the subject matter described in this application, a table for a vehicle includes a first table, a second table rotatably connected to the first table, a table rotation portion coupled to a boundary area between the first table and the second table and configured to provide friction to the first table and the second table based on the first table and the second table rotating to a folded position or an unfolded position, the table rotation portion being configured to fix the first table and the second table at a rotated position between the folded position and the unfolded position, and a gear portion coupled to the boundary area and configured to allow the first table and the second table to rotate by an equal rotation angle with respect to the unfolded position.

Implementations according to this aspect can include one or more of the following features. For example, the table rotation portion can include a hinge cover that is disposed at the boundary area and has a length corresponding to a length of the boundary area, a wing mounting guide coupled to the hinge cover, a pair of wing members that are coupled to the first table and the second table, respectively, and that are rotatably connected to the wing mounting guide, the pair of wing members being disposed at opposite sides of the wing mounting guide, respectively, a rotation guide coupled to the wing mounting guide and accommodated inside a wing member among the pair of wing members, the rotation guide being configured to guide a rotation path of the wing members, and an elastic member coupled to the wing mounting guide and configured to elastically support the wing member.

In some implementations, the wing mounting guide can be one of a plurality of wing mounting guides that are arranged linearly along the hinge cover and spaced apart from one another by a gap. In some examples, the plurality of wing mounting guides are mounted to the hinge cover. In some examples, the pair of wing members are disposed diagonally across the wing mounting guide.

In some implementations, the rotation guide can have an arc shape. In some examples, the elastic member can include a protrusion facing the wing member. In some implementations, the wing member defines a catch groove configured to receive the protrusion based on the wing member rotating relative to the wing mounting guide. In some examples, the catch groove can be one of a plurality of catch grooves that are arranged along an external circumferential surface of the wing member.

In some implementations, the gear portion can include a gear mounting guide mounted to the hinge cover, a pair of sliders that are coupled to the first table and the second table, respectively, that face each other, and that are rotatably mounted to the gear mounting guide, and a plurality of gear members that are mounted to the gear mounting guide and mesh with one another, the plurality of gear members being configured to guide the pair of sliders to rotate in conjunction with each other such that a rotation of any one of the pair sliders relative to the gear mounting guide by the equal rotation angle causes a remaining slider of the pair of sliders to rotate relative to the gear mounting guide by the equal rotation angle.

In some examples, the wing mounting guide is one of a pair of wing mounting guides disposed at the hinge cover, and the gear mounting guide is disposed between the pair of wing mounting guides.

In some implementations, the table rotation portion can be configured to define one plane with the gear portion based on the first table and the second table being at the unfolded position.

In some implementations, the table rotation portion is one of a plurality of table rotation portions that are between the first table and the second table, and the gear portion is one of a plurality of gear portions that are between the first table and the second table, where) the plurality of table rotation portions and the plurality of gear portions are alternately arranged along the boundary area. In some examples, the table can include a hinge cover that is disposed at the boundary area and has a length corresponding to a length of the boundary area, where the plurality of table rotation portions and the plurality of gear portions are coupled to the hinge cover.

In the present application, the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

### BRIEF DESCRIPTION OF THE DRAWINGS

The above and other features of the present disclosure will now be described in detail with reference to certain implementations thereof illustrated in the accompanying drawings which are given herein below by way of illustration only, and thus are not limitative of the present disclosure.

FIG. 1 is a view schematically illustrating an example of a table for a vehicle.

FIG. 2 is an exploded view illustrating an example of a table rotation portion and a gear portion of the table.

FIG. 3 is a combined view illustrating the table rotation portion and the gear portion of the table.

FIG. 4 is a view illustrating the table rotation portion of the table.

FIGS. 5 and 6 are views illustrating an example operation of the table rotation portion of the table.

FIG. 7 is a view illustrating the gear portion of the table.

FIG. 8 is a view illustrating an example operation of the gear portion of the table.

FIGS. 9A to 9C are views illustrating the structure of the table in a 180-degree rotated state.

FIGS. 10A to 10C are views illustrating the structure of the table in a 90-degree rotated state.

FIGS. 11A to 11C are views illustrating the structure of the table in a 0-degree rotated state.

FIG. 12 is a combined view of an example of a table rotation portion and a gear portion of the table.

FIG. 13 is a view illustrating an example of a protrusion for the table.

In the figures, the reference numbers refer to the same or equivalent parts of the present disclosure throughout the several figures of the drawing.

### DETAILED DESCRIPTION

Hereinafter, one or more implementations according to the present disclosure will be described in detail with reference to the accompanying drawings.

Advantages and features of the present disclosure, and a method of achieving the same, will be apparent with reference to the implementations described below in detail in conjunction with the accompanying drawings.

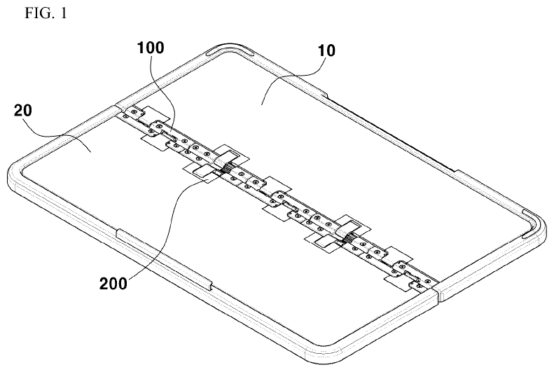

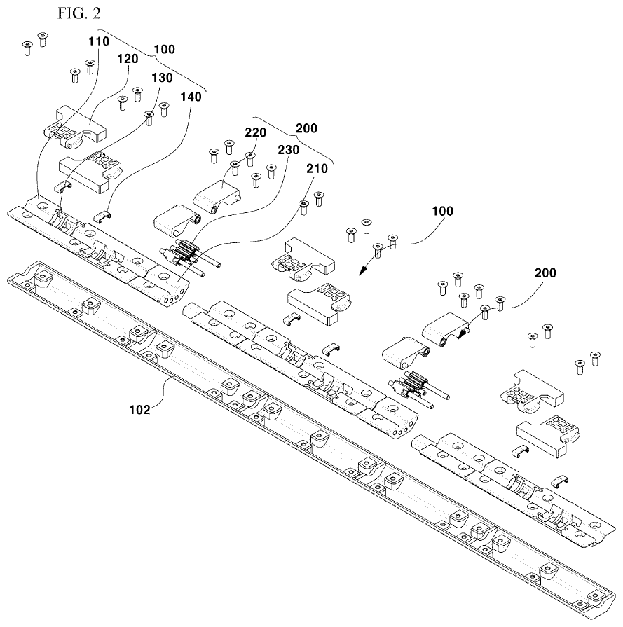

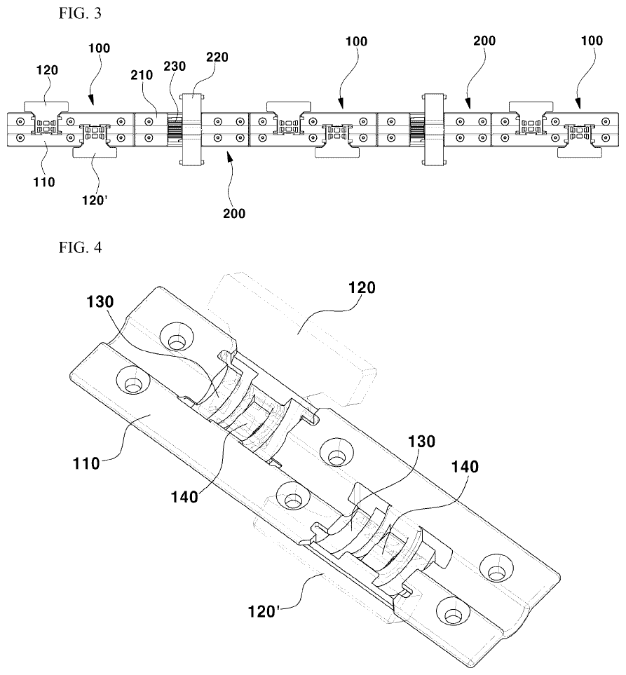

FIG. 1 is a view schematically illustrating an example of a table for a vehicle, FIG. 2 is an exploded view of a table rotation portion and a gear portion of the table, and FIG. 3 is a combined view of a table rotation portion and a gear portion of the table.

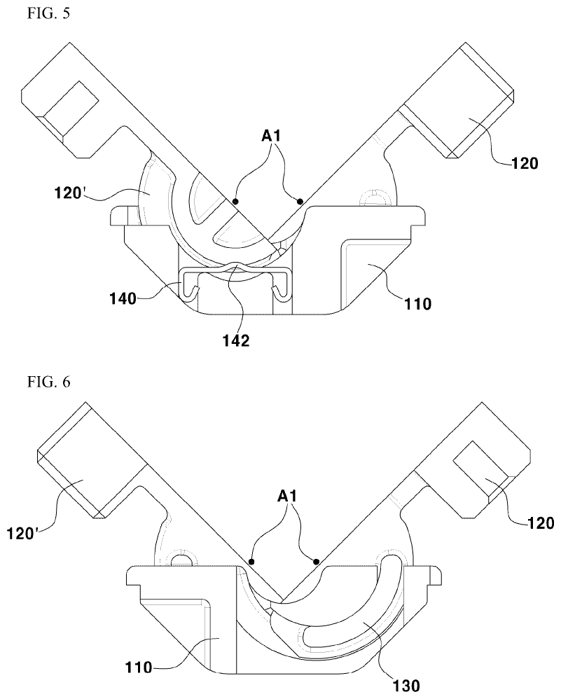

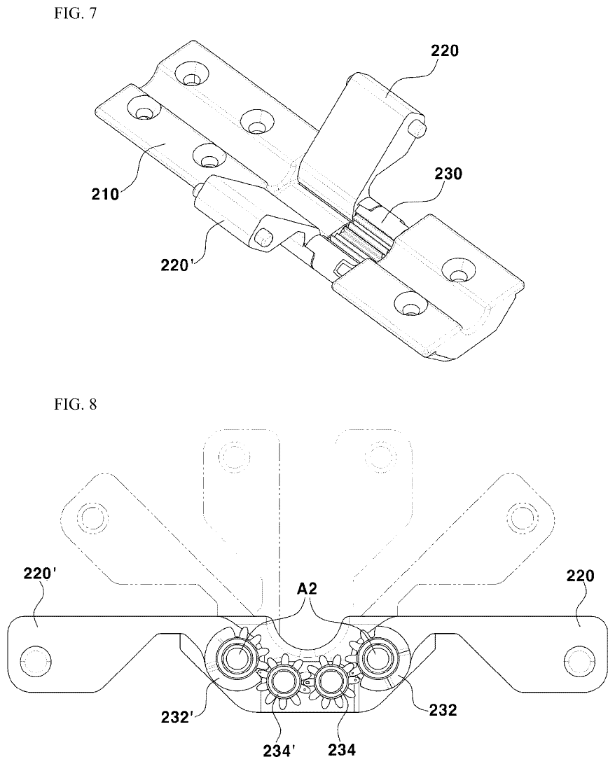

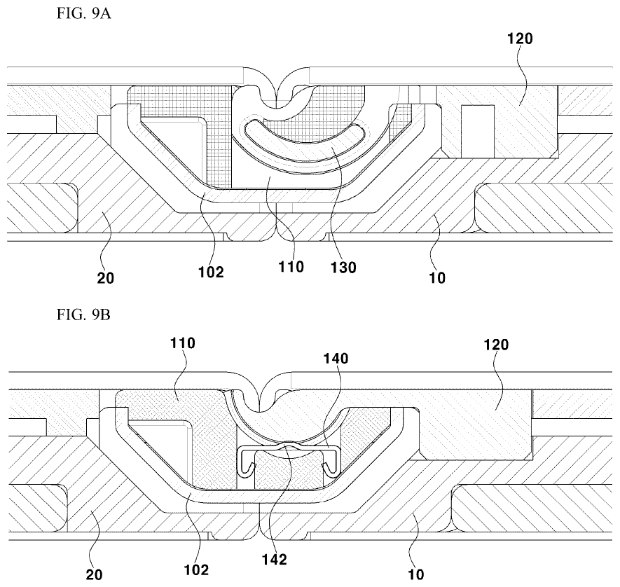

FIG. 4 is a view illustrating a table rotation portion of the table, and FIGS. 5 and 6 are views illustrating the operation of a table rotation portion of the table.

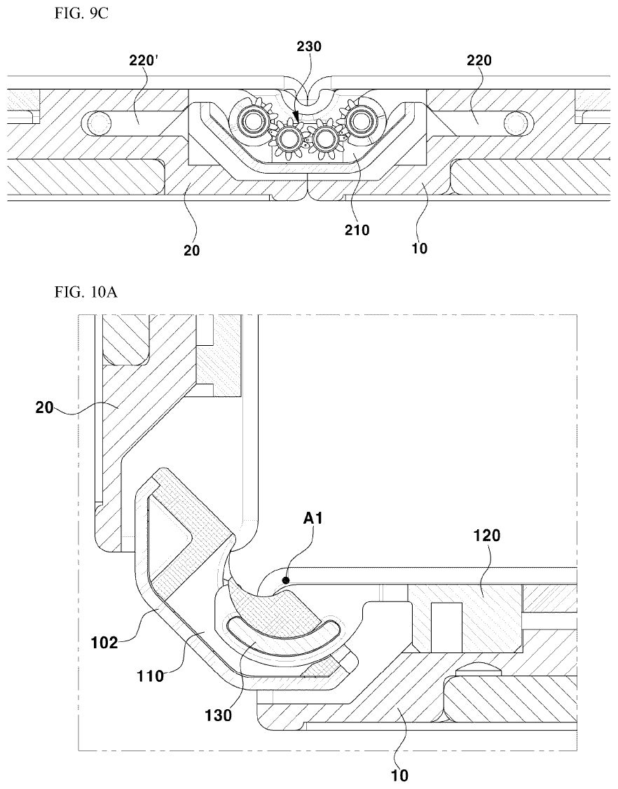

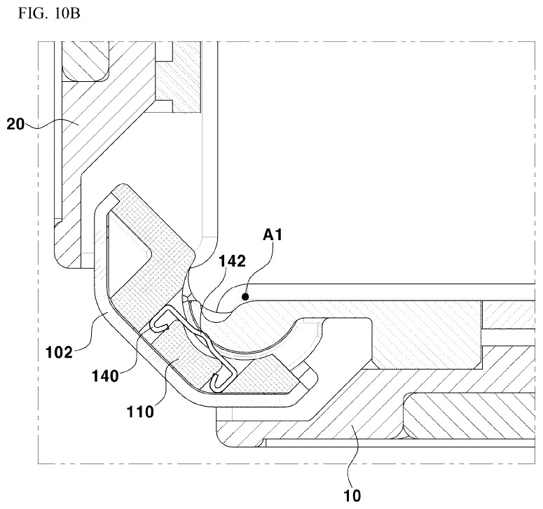

FIG. 7 is a view illustrating a gear portion of the table, and FIG. 8 is a view illustrating the operation of a gear portion of the table.

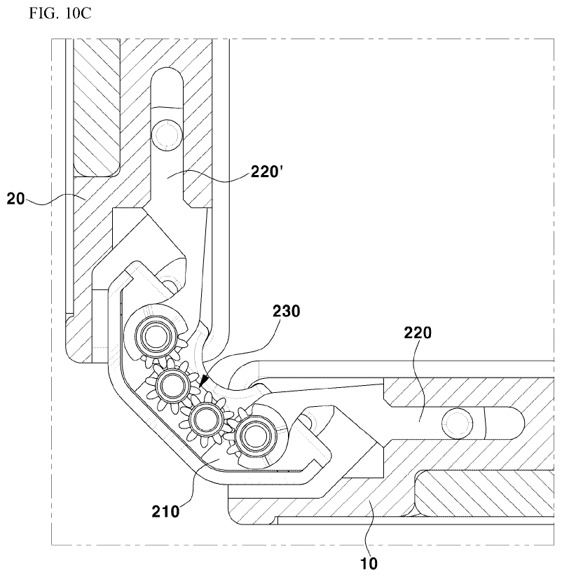

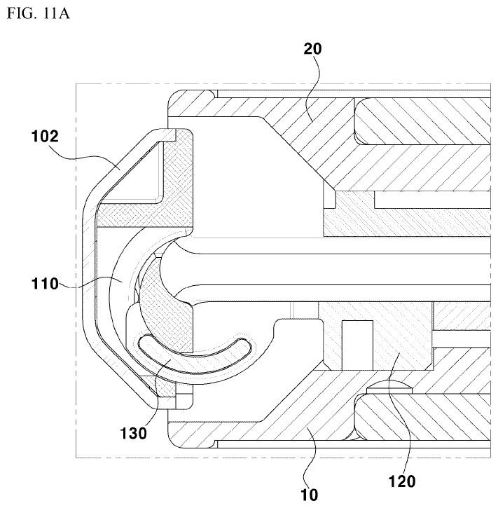

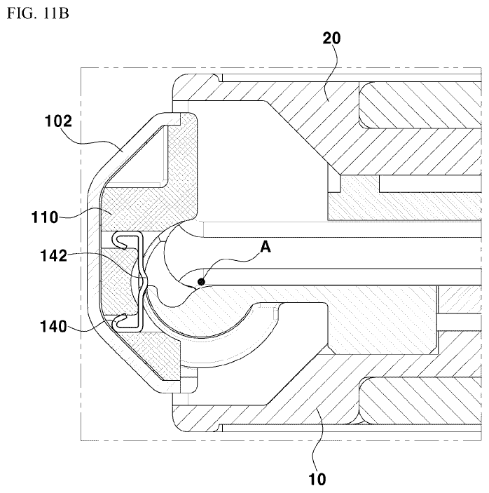

FIGS. 9A to 9C are views illustrating the structure of the table in a 180-degree rotated state, FIGS. 10A to 10C are views illustrating the structure of the table in a 90-degree rotated state, and FIGS. 11A to 11C are views illustrating the structure of the table in a 0-degree rotated state.

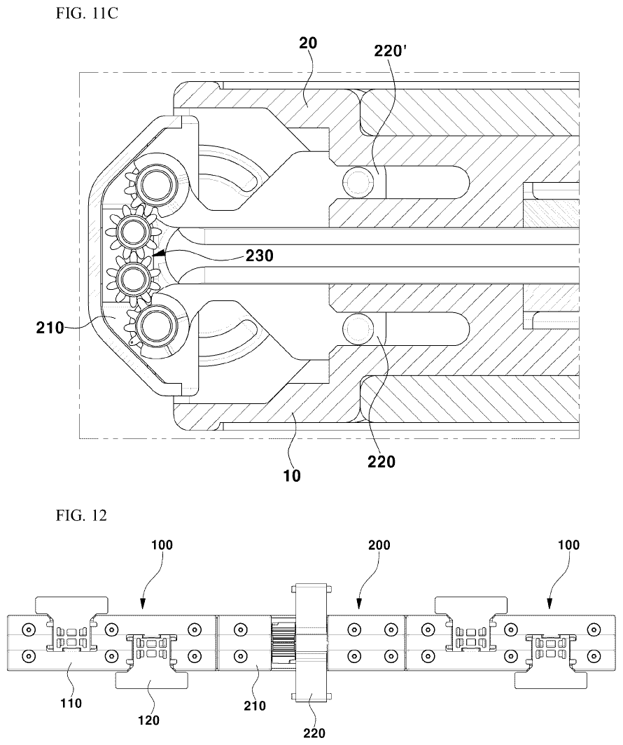

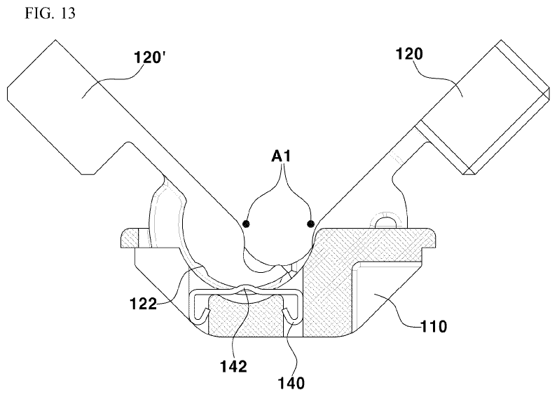

FIG. 12 is a combined view illustrating an example of a table rotation portion and a gear portion of the table, and FIG. 13 is a view illustrating a protrusion of the table.

As illustrated in FIG. 1, a table for a vehicle can be mounted on the back of a front seatback, the back of a rear seatback, a rear console, etc. of the vehicle, and includes a table rotation portion 100 and a gear portion 200.

In some implementations, the table rotation portion 100 can be coupled to the boundary area between a first table 10 and a second table 20, i.e., the area to fold the first table 10, which can be a lower table, and the second table 20, which can be an upper table.

The table rotation portion 100 together with the gear portion 200 can have a length corresponding to the width-wise length of the first table 10 and the second table 20 facing each other.

The table rotation portion 100 can form one plane with the gear portion 200 when the first table 10 and the second table 20 are unfolded to have a full flat surface (see FIG. 1), and accordingly, members constituting the table rotation portion 100, the gear portion 200, etc. may not protrude from the use surface, preventing inconvenience that may occur when there are some members protruding in the unfolded position.

In some implementations, the table rotation portion 100 can provide friction to the first table 10 and the second table 20 rotating to a folded or unfolded position so that the first table 10 and the second table 20 are fixed in the rotated position between the folded position and the unfolded positions.

In some examples, the table rotation portion 100 can include a wing mounting guide 110, wing members 120, 120′, a rotation guide 130, and an elastic member 140, as illustrated in FIG. 2.

The wing mounting guide 110 is mounted on a hinge cover 102 having a length corresponding to the length of the boundary area.

The wing mounting guide 110 can be provided in plurality and mounted in one line on the hinge cover 102, as illustrated in FIG. 3. The wing mounting guides 110 are mounted consecutively with the gear portion 200 placed therebetween.

At least two or more wing mounting guides 110 can be mounted on the hinge cover. In some examples, when the width-wise length of the first table 10 and the second table 20 is minimized as illustrated in FIG. 12, a minimum number of wing mounting guides 110, i.e., two wing mounting guides 110 are mounted on the hinge cover 102 with the gear portion 200 placed therebetween to make connection between the first table 10 and the second table 20 at the boundary area, providing friction to the first table 10 and the second table 20 in rotation.

In some implementations, the wing members 120, 120′ are provided as a pair and are arranged in a direction facing each other so that one side of one wing member 120 is coupled to the first table 10 and one side of another wing member 120′ is coupled to the second table 20.

In some examples, the pair of wing members 120, 120′ can be mounted diagonally across each other in the wing mounting guide 110. Specifically, another side of the wing member 120 can be rotatably mounted to one side of the wing mounting guide 110, and another side of the other wing member 120′ can be rotatably mounted to another side of the wing mounting guide 110.

The wing member 120 can have a “T” shape in which the width length of the one side thereof is shorter than the width length of the other side thereof.

The rotation guide 130 is, as illustrated in FIG. 4, coupled to the wing mounting guide 110 and accommodated inside the wing member 120, and is configured to guide the rotation path of the wing member 120.

The rotation guide 130 can have an arc shape with a predetermined curvature, and accordingly, as illustrated in FIG. 6, can guide the wing member 120 to rotate about a virtual rotation axis A1.

Therefore, when the wing member 120 rotates along the rotation guide 130 having a predetermined curvature (see FIG. 5), in other words, when the first table 10 and the second table 20 rotate, friction is generated as the first table 10 and the second table 20 rotate along the corresponding curvature, achieving a temporary fixation at the rotated position.

The elastic member 140 is configured to elastically support the other side of the wing member 120 by being coupled to the wing mounting guide 110, as illustrated in FIG. 5.

The elastic member 140 can be provided as a plate spring, and by elastically supporting the wing member 120 in rotation, friction can be provided to the wing member 120 and the rotation guide 130, achieving a temporary fixation of the wing member 120 at the rotated position.

In some implementations, as friction is provided by the rotation guide 130 and the elastic member 140 to achieve a temporary fixation of the wing member 120 at the rotated position, the first table 10 and the second table 20 each coupled to the one side of each of the pair of wing members 120, 120′ can be fixed in the folded or unfolded position.

In some examples, as illustrated in FIG. 13, the elastic member 140 can have a protrusion 142 protruding in a direction facing the wing member 120, and the wing member 120, 120′ can have a catch groove 122 into which the protrusion 142 is selectively inserted.

Because the elastic member 140 has the protrusion 142, protruding toward the wing member 120 to elastically support the wing member 120, and the wing member 120, 120′ has at least one catch groove 122, when the wing member 120, 120′ with the other side thereof being mounted to the wing mounting guide 110 rotates, the protrusion 142 can be selectively inserted into the wing member 120, 120′ at a position where the catch groove 122 is formed.

As such, when the protrusion 142 is inserted into the catch groove 122, the fixation force for the wing member 120, 102′ at the corresponding rotated position can be improved. Therefore, for example, by setting the position of the catch groove 122 in the wing member 120, 120′ at a spot where the protrusion 142 is inserted into the catch groove 122 when the first table 10 and the second table 20 rotate to form a 180-degree angle therebetween, the fixation force for the first table 10 and the second table 20 at the corresponding rotated angle can be improved, and thus, relatively heavy items can be stably placed on the table.

In some examples, by forming a plurality of catch grooves 122 at regular intervals along the external circumferential surface at the other side of the wing member 120, 120′ and allowing the protrusion 142 to be inserted into the catch groove 122, the fixation force applied to the first table 10 and the second table 20 can be improved at all rotated angles.

In some examples, when the first table 10 and the second table 20 are further rotated to the folded or unfolded position with the protrusion 142 being inserted into the catch groove 122, a locking or unlocking sound like a “click” can be made as the protrusion 142 is inserted into the next catch groove 122, providing the user with an operation sensitivity.

The gear portion 200 is, as illustrated in FIGS. 2 and 3, coupled to the boundary area by being arranged in line with the table rotation portion 100, and is configured to rotate at a rotation angle same as that of the first table 10 and the second table 20.

The gear portion 200 can include a gear mounting guide 210, sliders 220, 220′, and a gear member 230, as illustrated in FIG. 7.

The gear mounting guide 210 is mounted on the hinge cover 102, and more specifically, is mounted between the pair of wing mounting guides 110 on the hinge cover 102.

The sliders 220, 220′ are coupled to the first table 10 and the second table 20, respectively. The sliders 220, 220′ as a pair are arranged to face each other, and are mounted to be rotatable about a corresponding rotation axis A2 in the gear mounting guide 210.

The sliders 220, 220′ are provided as a pair and are arranged to face each other, such that one side of one slider 220 is coupled to the first table 10, and one side of the other slider 220′ is coupled to the second table 20.

In some examples, the pair of sliders 220, 220′ are mounted to face each other, and more specifically, another side of the one slider 220 can be rotatably mounted to one side of the gear mounting guide 210, and another side of the other slider 220′ can be rotatably mounted to another side of the gear mounting guide 210.

The gear member 230 is provided in plurality to be mounted to the gear mounting guide 210. The gear members 230 mesh with one another to guide the pair of sliders 220, 220′ to rotate in conjunction with each other, such that, when any one of the sliders 220, 220′ rotates, the other slider is guided to rotate in conjunction therewith at the same rotation angle.

As illustrated in FIG. 8, the gear members 230 include first gears 232, 232′ each being coupled to a corresponding rotation shaft A2, and second gears 234, 234′ each meshing with a corresponding one of the first gears 232, 232′. In some examples, the second gears 234, 234′ facing each other inside the gear mounting guide 210 mesh with each other.

In some implementations, when the first table 10 is rotated (see FIG. 8), one slider 220 rotates accordingly, and at the same time, the first gear 232 and the second gear 234 rotate, allowing the second gear 234′ meshing with the second gear 234 to rotate and the first gear 232′ to rotate, and eventually, the other slider 220′ rotates about the rotation axis A2 and the second table 20 rotates at the same rotation angle as the first table 10.

In some implementations, referring to FIGS. 9A to 9C, FIGS. 10A to 10C, and FIGS. 11A to 11C, the operations at different rotation angles between the first table 10 and the second table 20 are described as follows.

As illustrated in FIGS. 9A to 9C, when the first table 10 and the second table 20 rotate to form a 180-degree angle therebetween, the rotation guide 130 is positioned inside the wing member 120 coupled to the first table 10. In some examples, the wing member 120 is elastically supported by the elastic member 140 inside the wing mounting guide 110, fixing the wing member 120 at the rotated position.

In some examples, as the first table 10 and the second table 20 form a 180-degree angle therebetween, the pair of sliders 220, 220′ can also form a 180-degree angle therebetween and be fixed at the rotated position inside the gear mounting guide 210.

As illustrated in FIGS. 10A to 10C, when the second table 20 is lifted to be rotated at a 90-degree angle with respect to the fixed first table 10, the wing mounting guide 110 rotates about the rotation axis A1 along the rotation guide 130 to form a 45-degree angle, and as the wing mounting guide 110 rotates accordingly, the fixed elastic member 140 elastically supports the wing member 120 in a diagonal direction, thereby fixing the wing member 120 at the rotated position.

In some examples, as the first table 10 and the second table 20 form a 90-degree angle therebetween, the angle between the gear mounting guide 210 and the slider 220 changes and, in conjunction there with, the rotation angle of the slider 220′ coupled to the second table 20 also changes through the gear member 230, fixing the pair of sliders 220, 220′ inside the gear mounting guide 210 at a 90-degree angle.

As illustrated in FIGS. 11A to 11C, when the second table 20 is rotated with respect to the fixed first table 10 to form a 0-degree angle therebetween, i.e., when the second table 20 is rotated to the folded position, the wing mounting guide 110 rotates about the rotation axis A1 along the rotation guide 130 to form a 90-degree angle, and as the wing mounting guide 110 rotates accordingly, the fixed elastic member 140 elastically supports the wing member 120 in a lateral direction, thereby fixing the wing member 120 at the rotated position.

In some examples, as the first table 10 and the second table 20 form a 0-degree angle therebetween, the angle between the gear mounting guide 210 and the slider 220 changes and, in conjunction there with, the rotation angle of the slider 220′ coupled to the second table 20 also changes through the gear member 230, fixing the pair of sliders 220, 220′ inside the gear mounting guide 210 at a 0-degree angle.

As is apparent from the above description, the present disclosure provides the following effects.

In some implementations, the table can rotate and stop at any angle owing to the friction applied as the first table and the second table rotate to the folded or unfolded position, allowing the user to adjust the angle of the table as desired, thereby preventing injury caused by carelessness and improving convenience of use.

In some examples, at least one or more catch grooves are formed along the external circumferential surface of the guide wing so that the protrusion of the elastic member is caught in the catch grooves when the guide wing rotates, making the table to be securely fixed in the rotated position, and providing the user with an operation sensitivity when changing the rotational position of the table.

Furthermore, by mounting the gear members and sliders configured to link the rotation angle of the first table with the rotation angle of the second table, the first table and the second table can rotate in the same rotation radius.

In the above, implementations of the present disclosure have been described with reference to the accompanying drawings. However, those skilled in the art to which the present disclosure pertains will understand that various modifications can be made therefrom, and that all or part of the above-described implementations can be selectively combined. Therefore, the true technical protection scope of the present disclosure should be determined by the technical ideas of the appended claims.

What is claimed is:

1. A table for a vehicle, the table comprising:
a first table;
a second table rotatably connected to the first table;
a table rotation portion coupled to a boundary area between the first table and the second table and configured to provide friction to the first table and the second table based on the first table and the second table rotating to a folded position or an unfolded position, the table rotation portion being configured to fix the first table and the second table at a rotated position between the folded position and the unfolded position; and
a gear portion coupled to the boundary area and configured to allow the first table and the second table to rotate by an equal rotation angle with respect to the unfolded position.

2. The table of claim 1, wherein the table rotation portion comprises:
a hinge cover that is disposed at the boundary area and has a length corresponding to a length of the boundary area;
a wing mounting guide coupled to the hinge cover;
a pair of wing members that are coupled to the first table and the second table, respectively, and that are rotatably connected to the wing mounting guide, the pair of wing members being disposed at opposite sides of the wing mounting guide, respectively;
a rotation guide coupled to the wing mounting guide and accommodated inside a wing member among the pair of wing members, the rotation guide being configured to guide a rotation path of the wing members; and
an elastic member coupled to the wing mounting guide and configured to elastically support the wing member.

3. The table of claim 2, wherein the wing mounting guide is one of a plurality of wing mounting guides that are arranged linearly along the hinge cover and spaced apart from one another by a gap.

4. The table of claim 3, wherein the plurality of wing mounting guides are mounted to the hinge cover.

5. The table of claim 2, wherein the pair of wing members are disposed diagonally across the wing mounting guide.

6. The table of claim 2, wherein the rotation guide has an arc shape.

7. The table of claim 2, wherein the elastic member comprises a protrusion facing the wing member.

8. The table of claim 7, wherein the wing member defines a catch groove configured to receive the protrusion based on the wing member rotating relative to the wing mounting guide.

9. The table of claim 8, wherein the catch groove is one of a plurality of catch grooves that are arranged along an external circumferential surface of the wing member.

10. The table of claim 2, wherein the gear portion comprises:
a gear mounting guide mounted to the hinge cover;
a pair of sliders that are coupled to the first table and the second table, respectively, that face each other, and that are rotatably mounted to the gear mounting guide; and
a plurality of gear members that are mounted to the gear mounting guide and mesh with one another, the plurality of gear members being configured to guide the pair of sliders to rotate in conjunction with each other such that a rotation of any one of the pair of sliders relative to the gear mounting guide by the equal rotation angle causes a remaining slider of the pair of sliders to rotate relative to the gear mounting guide by the equal rotation angle.

11. The table of claim 10, wherein the wing mounting guide is one of a pair of wing mounting guides disposed at the hinge cover, and the gear mounting guide is disposed between the pair of wing mounting guides.

12. The table of claim 1, wherein the table rotation portion is configured to define one plane with the gear portion based on the first table and the second table being at the unfolded position.

13. The table of claim 1, wherein the table rotation portion is one of a plurality of table rotation portions that are between the first table and the second table,
wherein the gear portion is one of a plurality of gear portions that are between the first table and the second table, and
wherein the plurality of table rotation portions and the plurality of gear portions are alternately arranged along the boundary area.

14. The table of claim 13, further comprising:
a hinge cover that is disposed at the boundary area and has a length corresponding to a length of the boundary area,
wherein the plurality of table rotation portions and the plurality of gear portions are coupled to the hinge cover.
